(19) United States
(12) Patent Application Publication
(10) Pub. No.: US 2016/0239453 A1
(43) Pub. Date: Aug. 18, 2016

(54) METHOD OF EVALUATING A CHANNEL

(71) Applicant: Molex, LLC, Lisle, IL (US)

(72) Inventors: Davi Correia, Aurora, IL (US); Scott Sommers, Naperville, IL (US)

(73) Assignee: Molex, LLC, Lisle, IL (US)

(21) Appl. No.: 15/042,787

(22) Filed: Feb. 12, 2016

Related U.S. Application Data
(60) Provisional application No. 62/115,490, filed on Feb. 12, 2015.

(51) Int. Cl. G06F 13/40; G06F 13/42

(52) U.S. Cl. CPC G06F 13/4068; G06F 13/4282

(57) ABSTRACT

A method of providing information at a channel level is provided. Each component of the channel can be represented by pre-calculated s-parameter matrix. Selection of the components allows the s-parameter matrices to be combined together to form an s-parameter matric representative of the channel. The channel can then be evaluated to determine if it meets desired criteria. Changes to the channel can be quickly evaluated by selecting different components or different configurations of the channel.

### RELATED APPLICATIONS

This applications claims priority to U.S. Provisional Application No. 62/115,490, filed Feb. 12, 2015, which is incorporated herein by reference in its entirety.

### TECHNICAL FIELD

This disclosure relates to field of systems configured to evaluate communication channels.

### DESCRIPTION OF RELATED ART

Channel evaluation has become an important part of developing a system that is capable of operating at a high data rate. A typical communication channel will include a first chip on a first circuit board, a connector system to couple the first circuit board to a second circuit board and a second chip. While such a system sounds simple to evaluate it turns out to be relatively complex.

As data rates increase the signal frequency has also increased and it is now common for signaling frequencies to be greater than 10 GHz. Very minor variations in hardware can have a significant impact on the system performance and for higher performance configurations where the margin is smaller even a small change can cause a system to cease to function as intended. As a result, it has become more important to test out architecture to determine if a particular hardware configuration is compatible with the planned signaling schema.

While physical testing is perhaps the most important test, trying to test with actual samples has a number of limitations that makes it unsuitable to early phases of development. While a computer model of a part can often be developed in a matter of days, building physical samples may take weeks or months. Relying on physical samples would case the development time to be stretched to the point where design work becomes nearly impossible (if one is hoping to keep up with changes in technology). In addition to being too slow, physical models have to be built off production tooling in order to provide a reliable picture of the expected results as a system of prototype parts could well have a performance delta compared to a system of production parts. Using prototype parts is also quite expensive as certain components have to be built off low volume tooling to at least get a reasonable approximation of the final system.

Rather than build prototypes it has become common to first build accurate computer models and determine if the performance of the individual matches the expected performance target. If the components can meet the performance requirements individually then a computer model of the entire system can be generated and tested. Unfortunately this generation of the computer model representative of the entire system is time consuming. Accordingly, certain individuals would appreciate further improvements in a system that can help provide more timely feedback regarding the performance of a channel.

### SUMMARY

A method of evaluating a channel can include selecting components of the channel. The components each have properties that can be characterized by an s-parameter matrix. Combining the various s-parameter matrices together allows for the forming of an s-parameter matrix that defines the performance of the channel. The s-parameter matric of the channel can be used to evaluate the performance of the channel and can be used to determine whether the channel is compatible with particular standards and/or particular transceivers.

### BRIEF DESCRIPTION OF THE DRAWINGS

The present invention is illustrated by way of example and not limited in the accompanying figures in which like reference numerals indicate similar elements and in which:

FIG. 1 illustrates an embodiment of a system that can be used to evaluate a channel.

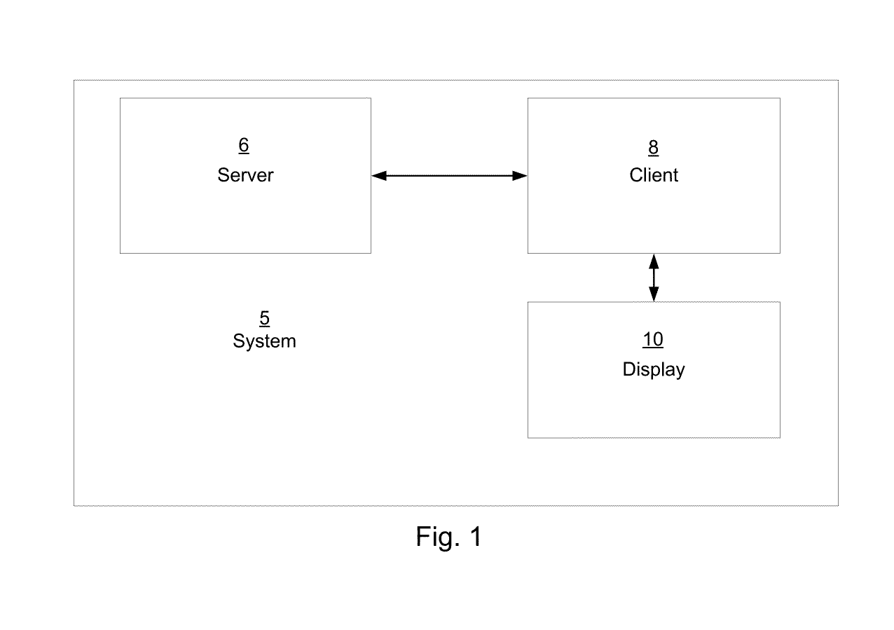

FIG. 2 illustrates a schematic representation of a screen that can be used to evaluate a channel.

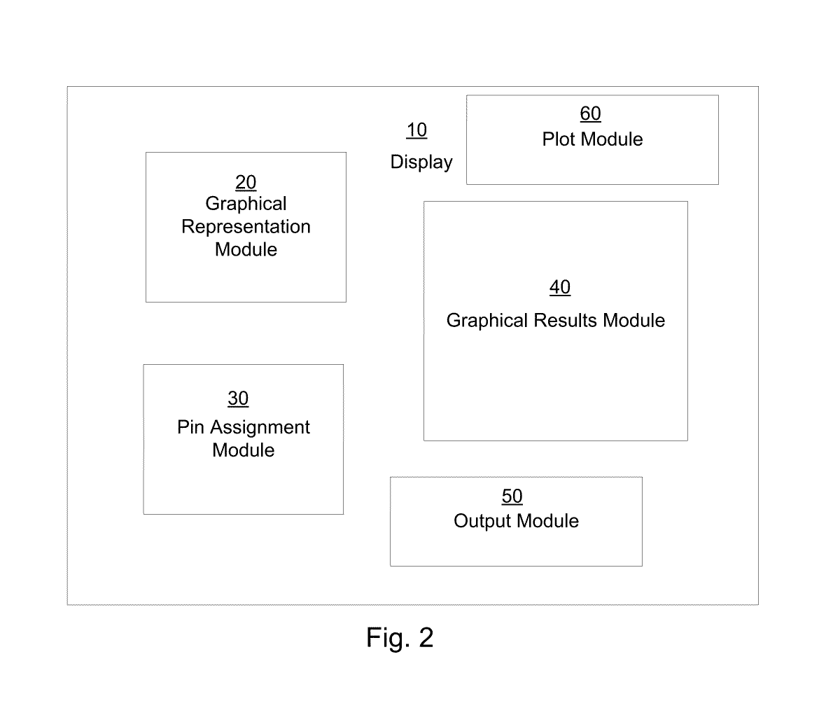

FIG. 3 illustrates of an embodiment of a method of evaluating a channel

FIG. 4 illustrates a graphical indication of a victim pair in a channel.

FIG. 5 illustrates a graphical depiction of an interface that allows a channel to be defined.

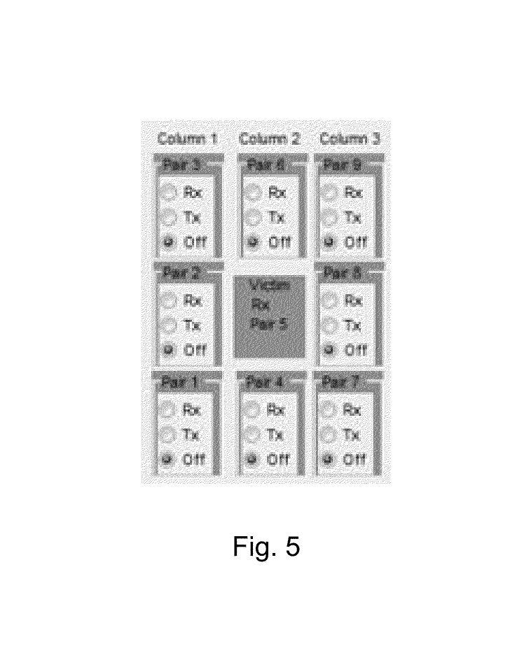

FIG. 6 illustrates an embodiment of an eye chart that can be provided when evaluating a non-return to zero (NRZ) signal.

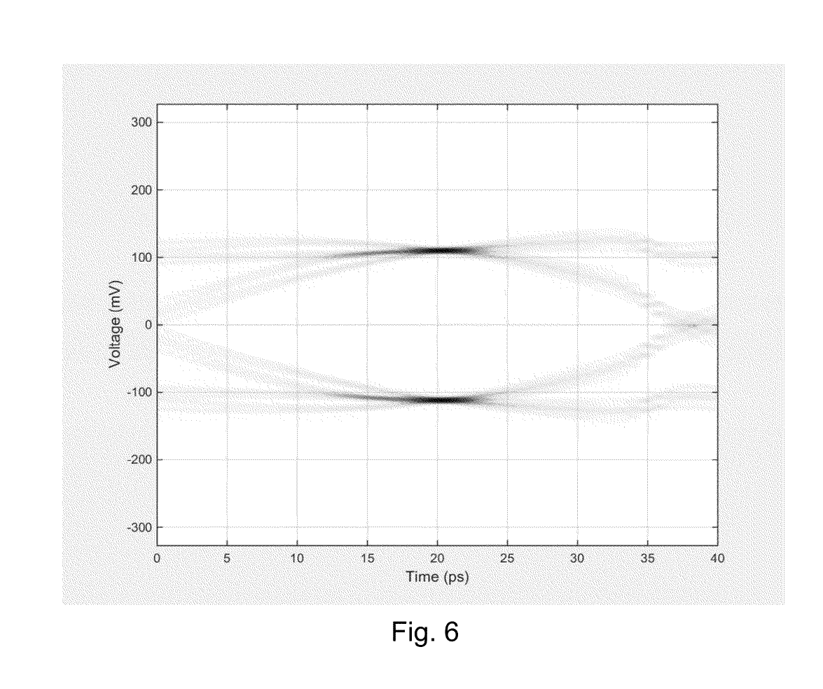

FIG. 7 illustrates an embodiment of an eye chart that can be provided when evaluating a pulse-amplitude modulation level 4 (PAM-4) signal.

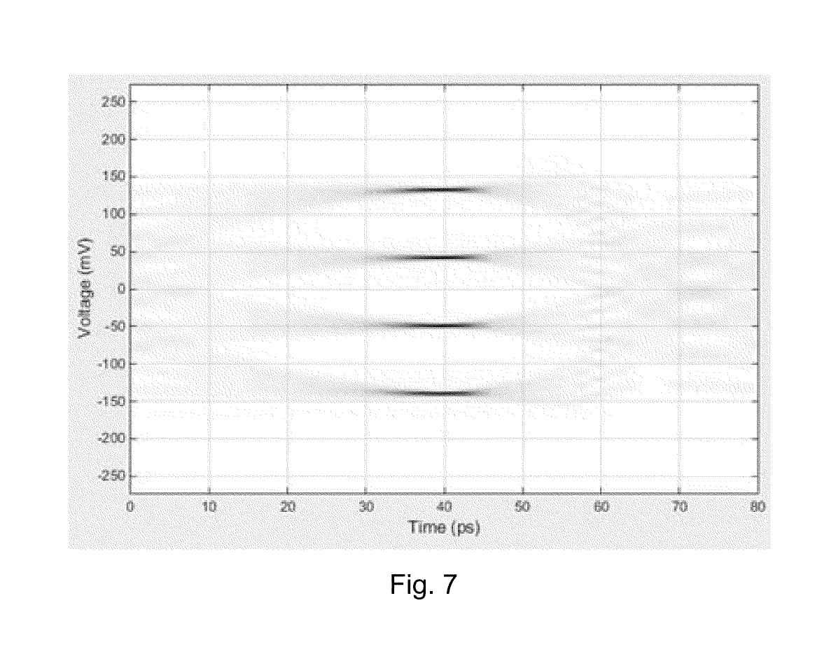

FIG. 8 illustrates an embodiment of a plot depicting insertion loss and crosstalk.

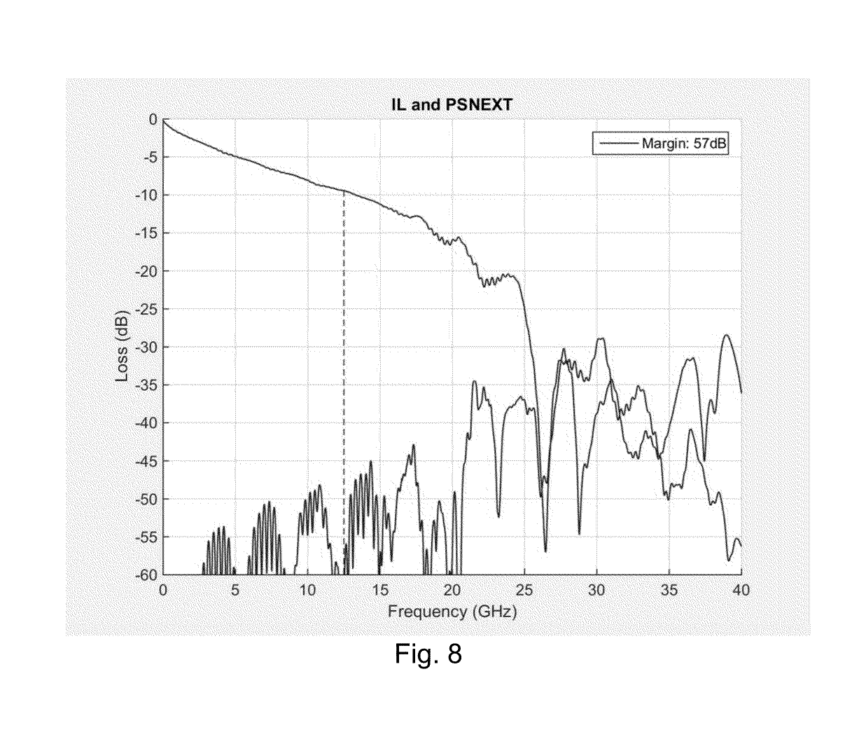

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

As can be appreciated from the Figures, a system 5 can be provided that provides certain functionality. It should be noted that the system 5 is depicted as including a server 6, a client 8 and a display. As is known there are a wide range of configurations for computing systems. In some embodiments a computing system can have a client (which could be one or more distinct processing units, memory and other standard hardware elements) adjacent the display, in other embodiments of a computing system the display and the client can be separated by some arbitrary distance so that the client is considered a server and the server and the display can communicate together through wired or wireless network (or some combination thereof). In yet other embodiments the computing system can include a combination of one or more clients and one or more servers. Thus the depicted server 6 is optional in embodiments where the client 8 includes the necessary configuration and information to support the system. Similarly the client 8 is optional if the server 6 is configured to support the system 5.

As can be appreciated, in certain embodiments a computing system can include a display and the client integrated into a single device. Thus in certain embodiments the depicted elements of the system 5 can be considered as logically separated rather than requiring physical distinctness.

In one embodiment the computing system will include a client 8 that includes an interface engine and the client 8 will be configured to interact with the server 6 via the interface engine. The interface engine can be as simple as a protocol for passing data between the client 8 and the server 6 or it can be more featured and similar to a web browser. The optional interface engine, if included in the client 8, helps facilitate interactions between the client 8 and the server 6.

The client 8 and/or the server 6 are configured to provide selected information on the display 10 and thus can include various modules that allow the corresponding information to be so displayed. Thus, portions of the module can be located on the client 8, on the server 6 or on a combination of the client 8 and server 6 (and if the client is physically combined with the display, the modules can located on the display). The modules can have a graphical interface provided on the display 10. In an embodiment the modules can include a graphical representation module 20, a pin assignment module 30, a graphical results module 40, an output module 50 and a plot module 60. Naturally additional modules can be added if desired and these modules can be selectively provided on the display 10. In addition, as can be appreciated, the discussed modules can be combined together. Therefore, the depicted breakdown is more representative of a logical separation then actual separation.

The graphical representation module 20 allows a user to select a configuration that matches the desired physical environment that is desired to be evaluated. Depending on the configuration, the graphical representation module 20 can include a large variety of different geometries for connectors, including but not limited to right angle connectors, vertical connectors, straddle mount connectors, angled connectors, etc. If desired, cables can also be provided as a component and such a component would include identification of a specific cable and the desired length. In an embodiment the graphical representation module 20 can include different graphical illustrations that represent the different types of connectors that can evaluated. For certain connector types, such as backplane connectors, a type of connector can be selected along with a size of the connector. This allows for a selection of a backplane connector that is configured to provide, for example but without limitation, a three pair, a four pair, a five pair, etc., whatever size is desired for the particular application. For standard IO connectors such size selection will typically not be applicable as IO connectors usually come in a single size.

Selecting the appropriate configuration of boards and connector system with the graphical representation module 20 results in the selection of a number of s-parameter matrices that each represents the performance of the respective component. To speed up operation of the evaluation, the s-parameter matrices for each option can be pre-generated (.e.g., generated in advance). In an embodiment the graphical representation module 20 can also selectively provide additional information about choices (such as details about construction or geometry) so that it is possible to more closely match the intended real world use case with the system being evaluated.

An optional pin assignment module 30 allows for the selection of which pins are used as transmit pair and which pins are used as receiving pair. This is useful in connectors where the pins can be configured to act as a transmit pair or a receiving pair (with respect to the end that one is starting on). For example, backplane connectors are often designed so that any particular high data-rate capable pair can function as a transmit or a receive pair and the particular configuration used depends on the application. The result of such flexibility is that a configuration can be selected that matches the intended use case and the selected configuration may have one or more transmit pairs and one or more receiving pairs adjacent the pair being evaluated. As can be appreciated, having an adjacent transmit pair will tend to introduce near end crosstalk (NEXT) and having an adjacent receiving pair will tend to introduce far end crosstalk (FEXT). In certain input/output (I/O) applications, however, the connector, including which pairs acts as transmitting or receiving pairs, is defined by a standard and there is no need to have the ability to configure the pairs differently.

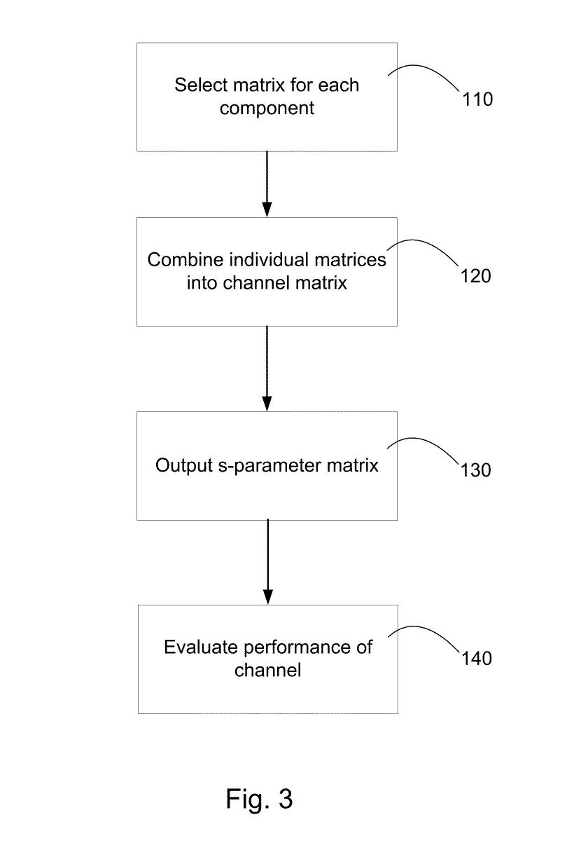

FIG. 3 illustrates an embodiment of the process. In step 110, after receiving a selection of the components, an s-parameter matrix is selected for each component. In step 120 the s-parameter matrices of the selected components are combined into a channel matrix. In step 130 the channel matrix is converted back into an s-parameter matrix that represents the channel. In optional step 140 the performance of the channel can be evaluated. Additional details about these steps are provided below.

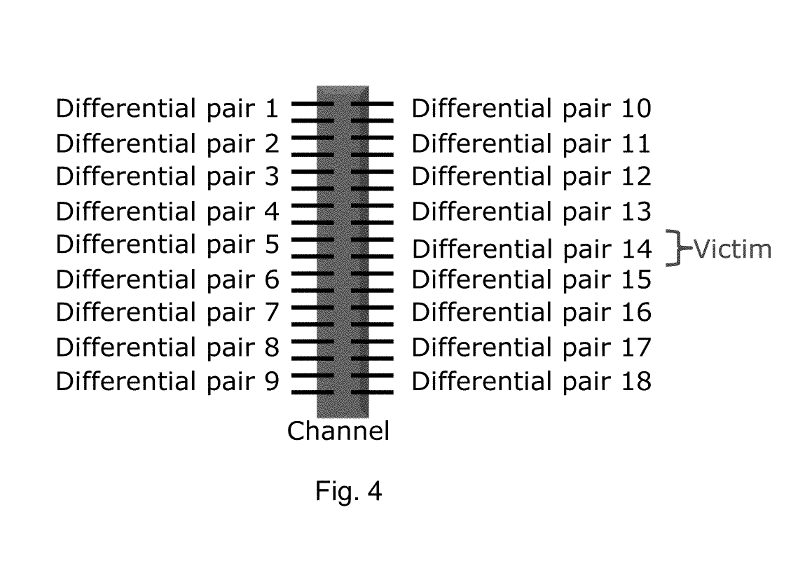

The graphical results module 40 is configured to display results of an evaluation and work in conjunction with the plot module 60. In an embodiment, the combination of the graphical results module 40 and plot module 60 converts each of the s-parameter matrices into a corresponding ABCD matrix. This can be done in a conventional manner, for example, by using the MATLAB function s2abcd. The individual matrices can then be combined using convention matrix algebra. The resultant ABCD matrix can then be converted back into an s-parameter matrix (for example, by using the MATLAB function abcd2s). The resultant combined s-parameter matrix is representative of the entire channel and, as depicted by FIG. 4, can be a combination of multiple differential pairs. It is expected that the use of 9 differential pairs (a victim pair surrounded by 8 pair) provides a reasonably representative system. Once the s-parameter matrix is obtained it can be used to provide various illustrations based on input provided to the plot module 60. For particular applications, such as an industry standard, a plot of insertion loss versus crosstalk can be compared to requirements defined by that standard. Thus it would be possible to compare a selection to various standard requires such as are mandated by PCIe Rev3, SAS 4.0, etc. and see if the selected configuration would meet all, some or none of the standard requirements. If desired, the system 5 could also provide a list of standards that the channel being evaluated would be expected to meet.

The output module 50 can generate a file that includes the s-parameter of the resultant system. This s-parameter file can used to evaluate whether particular transceivers will function in the desired system (and thus whether they would be useful in the marketplace). In addition, or alternatively, the output module 50 can output a channel report that provides details of the selected configuration. The output module 50 may also provide one or more plots of items of interest, including a comparison of insertion loss versus some crosstalk plot. Naturally multiple plots can be provided to provide comparison between various types of cross talk and potential losses. Return loss, time-domain reflectometer, eye charts (NRZ or PAM 4) as well as similar plots and information such as a channel operating margin (COM) values can also be included in the channel report.

It should be noted that if desired, additional features could be added to the system. In one embodiment a transceiver could be characterized and a representative module could be used to power the transmitting pairs (either on one side or both sides of the defined channel). This would allow for a rapid evaluation of not just the channel but also the effectiveness of a particular silicon design in that channel, something that would be beneficial to hardware architects. Naturally, the evaluation could also be based on a generic chip that simulates a typical performance. For greater accuracy, however, it is generally desirable to use characteristics of an actual chip design.

As noted above, a COM value can also be provided. The COM value, which is ratio of available signal amplitude (As) to statistical noise amplitude (An), expressed in dB where:

COM=20*log₁₀(As/An)

It should be noted that the channel can be, and preferably is, the entire physical electrical connection between a transmitter and a receiver block. Thus, as can be appreciated, the system 5 is well suited to provide a COM value.

As can be appreciated, one benefit of the system 5 is that a system architect can plan a system that defines certain differential pairs as transmits and receives and then quickly test the system. The ability to check both NRZ and PAM 4 compatibility is useful for applications where both are possible choices.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A method, comprising:
receiving a selection of a plurality of components, the plurality of components defining a channel;
selecting an S-parameter matrix for each of the components that make up the plurality of components;
forming a channel matrix based on the selected s-parameter matrices;
converting the channel matric into an S-parameter matrix.

2. The method of claim 1, wherein the receiving of the selection includes receiving an selection of a first connector and a second connector, the first and second connectors being approximate opposite ends of the channel.

3. The method of claim 2, wherein the receiving of the selection include receiving an indication of a cable type and length.

4. The method of claim 1, wherein the receiving the selection includes receiving a first board type and a first routing length, receiving a first connector with a first configuration, receiving a second connector with a second configuration and receiving a second board type and a second routing length.

5. The method of claim 1, wherein the selecting step includes selecting the S-parameter matrix that is pre-generated for the components.

6. The method of claim 1, wherein the form a channel matric includes converting each of the S-parameter matrices for the plurality of components into an ABCD matrix and combining the ABCD matrices using matrix algebra to form the channel matrix.

7. The method of claim 1, further comprising the step of determining insertion loss and crosstalk for the channel.

8. The method of claim 7, further comprising the step of comparing insertion loss and crosstalk with a predetermined set of requirements.

9. The method of claim 8, further comprising the step of providing an indication of whether the channel meets the predetermined set of requirements.

10. The method of claim 1, further comprising providing a channel operating margin (COM) value for the channel.

11. The method of claim 1, wherein the receiving of the selection includes displaying a graphic depiction of components and receiving an indication of which components are being selected.

12. The method of claim 1, further comprising the step of evaluating the channel based on a predetermined transmit and receive capability.

13. The method of claim 12, wherein the predetermined transmit and receive capability are based on a characterization of a typical transceiver performance.
